(19) United States
(12) Patent Application Publication
(10) Pub. No.: US 2013/0080238 A1
(43) Pub. Date: Mar. 28, 2013

(54) Method and System for Operating a Customer or Player Loyalty System Including a Portable Device Such as a Smartcard

(71) Applicants: Bryan Kelly, Pleasanton, CA (US); Joe Lerner, Reno, NV (US); Martin Lyons, Las Vegas, NV (US)

(72) Inventors: Bryan Kelly, Pleasanton, CA (US); Joe Lerner, Reno, NV (US); Martin Lyons, Las Vegas, NV (US)

(21) Appl. No.: 13/240,890

(22) Filed: Sep. 22, 2011

(51) Int. Cl. G06Q 30/00

(52) U.S. Cl. 705/14.31; 705/14.27

(57) ABSTRACT

A method and system are set forth which include one or more terminals providing near field communication with an electronic device held by the user such as a smart card. The device includes a display panel configured to persistently display a visual condition associated with the user's account, promotional status or as selected by the user.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention relates to systems and methods for operating a customer or player loyalty and electronic payment system such as a loyalty system for one or a family of affiliated gaming venues, e.g. casinos. More particularly it relates to operating such systems and methods where the customer or player possesses a portable device with a degree of computing capability and memory such as a key fob or smartcard, perhaps issued to users by a business, or a device such as a personal data assistant (PDA), cellular telephone, or portable computing device in possession of the user.

### BACKGROUND

It is generally known to provide customers with rewards, discounts, prizes and gifts as part of a loyalty program. For example, in the gaming industry, casino properties offer to players the ability to join a players club also known as a loyalty club. At registration into the club the enrollee provides information such as name, address and other personal information. The enrollee may also provide biometric information such as a facial scan, fingerprint, retina or other biometric characteristic to identify the enrollee. In addition to such information the enrollee is required to select a personal identification number (PIN) associated with the enrollee's account. This information is recorded into a player account disposed in a data structure accessible by a player club host computer. The player is issued a loyalty card which typically appears like a plastic credit card having pre-printed front and back sides for example with the club or casino name and club related graphics. A card writing device at the registration area prints/embosses the player's name on the card, a numeric player account number and encodes a magnetic, machine readable, stripe on the card with information such as a property indicator, the player's account number or tag or other desired information to draw an association through the system between the card and the player's account at the data structure.

In association with the loyalty club, loyalty card readers are installed on all of the gaming machines and are provided in association with table games, promotional kiosks and at points of sale. The card readers are configured to receive an inserted or swiped loyalty card and to read the magnetic stripe. Through a communication network at the property or across several properties, the card readers communicate with the host computer to access the player accounts and to draw an association with account assigned to the player identified by the loyalty card. As a player engages in commercial activity such a purchases and gaming he/she accumulates “player points” (typically related to the “spend” by the player) which entitle the player to several benefits. One benefit is that the player can be rated into one of a plurality of player ratings groups or tiers. The casino may, for example, have a silver group for low valued players, a gold group for higher valued players and a platinum group for the highest valued players. Ranking can be based upon several criteria selected by the casino such as time at play, player spend, player wagers, and the like. These and other factors are used to access the worth or value of the player to the casino. The higher the player is rated the more valuable the promotions the player is entitled to. Highly rated players may be entitled to free stays at the casino property, gifts, show tickets and the like. The ratings can also be used to configure marketing promotions issued to players either by mail or through the Internet.

Examples of loyalty systems in a gaming environment are described in Bryant, et al US Published Application 2008/0274800 and Boushy, U.S. Pat. No. 5,761,647 the disclosures of which are incorporated by reference. It has been suggested that a smartcard be used for such loyalty card applications. See Bryant, et al US Published Application 2008/0274800 and Kelly, et al US Published Application 2009/0176565 the disclosures of which is incorporated by reference.

Loyalty systems such as type describe above have been used by commercial retailers as well such major grocery store chains, airlines and the like.

In regards to smart cards, it has been known, for example in the public transportation, vending and other industries, to use smartcards as well as devices such as cellular telephones to upload/download data such as payment funds with a terminal using near-field communication (NFC) or other short range communication technologies. NFC is a short range communication technology implemented using electromagnetic radiation. For example, in Loh, et al US Published Application 20090143104 titled “Wireless Smart Card and Integrated Personal Area Network, Near Field Communication and Contactless Payment System”, the disclosure of which is incorporated by reference, there is disclosed a smart card which can be used for communication or for use with a portable device such as a PDA or cellular telephone and a system.

In the casino industry it is also known to have gaming machine with ticket-in, ticket-out (TITO) functionality. In an industry step to eliminate the need for coin hoppers in gaming machines and handling associated with gaming machines operating with coins (e.g. coin counters, handlers and change personnel), devices and systems were developed which enabled gaming machines to print a ticket/voucher which represents the value of credits on a gaming machine. The player prompts the gaming machine to print a ticket which can then be redeemed for cash at a kiosk or casino cage or uses the ticket to establish gaming credits at another gaming machine. Burns et al U.S. Pat. No. 6,729,958 titled “Gaming System With Ticket-In/Ticket-Out Capability” and Baltz et al, U.S. Pat. No. 7,704,143 titled “Apparatus and Method for a Cashless Actuated Gaming System”, the disclosures of which are incorporated by reference, disclose TITO systems. Today TITO is used throughout the casino industry.

A drawback with TITO is that coin handling has now been replaced with ticket handling. Gaming machines must be equipped with ticket printers and readers (typically combined with currency readers) and the casino must handle and store the tickets for accounting, regulatory and tax purposes. Ticket handling includes replenishment of tickets at ticket printers including staff time, maintenance of ticket printers and supporting communication network as well as storing the perhaps thousands of tickets printed per day at the casino. There is a need to minimize or eliminate the drawbacks of TITO.

In the gaming field it has been known to provide a “saved state” functionality. Basically such functionality enables a player to achieve a “state”, condition or entitlement during play of a gaming machine and to save that state for later play on the same or similar gaming machine. Examples of this functionality is described, for example, in Luciano, Jr. et al U.S. Pat. No. 6,758,757 entitled “Method and Apparatus for Maintaining Game State”, Luciano, Jr. U.S. Pat. No. 6,811,486 entitled “Method and Apparatus for Enhancing Game Play Through Savable Game Play State”, and Luciano, Jr. et al U.S. Pat. No. 6,923,721 entitled “Apparatus and Method for Maintaining Game State” the disclosures of which are incorporated by reference. In U.S. Pat. No. 6,758,757 an arrangement is described where the game state is saved via a media such as a ticket or smart card or other information storage medium. There is a need in connection with a saved state functionality to provide the player with a reference by which the user can recall the state saved for one or several games. For example, the user may play several different types of games and have different saved states or features for each. There is a need for the player to be able to save the state and to determine, apart from the games, the player's saved state condition.

Saved state can also be applied to providers other than in the gaming industry such as the state the user has achieved in relation to an ongoing promotion.

It is submitted that the use of smart cards and portable devices such as PDAs and cellular telephones has not been fully explored or utilized in connection with rewards, payment and promotions in the gaming and other industries. There is a need to provide a smart card/portable device, method and system which provides for rewards, promotions, payments and other functions to enhance the loyalty and functional aspects of a loyalty and debit/credit system.

### SUMMARY OF THE INVENTION

In accordance with one aspect of the invention/s, there is set forth a system and method for operating a loyalty system for an environment including a plurality of user terminals, a system host computer, a data structure, a communication network between the host computer and the terminals and a portable device in possession of each user. Each portable device includes a controller to control a visual display which includes or has a separate visually configurable panel. The portable device may be a smart card or key fob configured according to the one or more aspects of the present invention, a cellular telephone, personal digital assistant (PDA), portable computer or other portable device or a combination of such devices. The method includes the steps of storing at said data structure data corresponding to one or more of user account data and promotional data and enabling the portable device controller to be placed into communication with the network such as by interfacing with a user terminal using near field communication (NFC) technology. One or more of the controller and host controls the display to display a message and the panel to display a visual state corresponding to one or more of said account data and said promotional data. The visual state may be a color or a pattern, icon, logo, graphic or a combination thereof.

The system and method according to one embodiment stores at a data structure data corresponding to a ranking assigned to each user and controlling one or more of the device display and panel to assume a visual state corresponding to said ranking. The visual state may be a color, pattern, symbol, animation, graphic, video presentation or other visual presentation

Where the device is a smart card, for example, the panel may be a surface of the card such as all or a portion of one side of the card defined by an e-ink panel.

The system and method may include providing for the storage of data corresponding to a value at one or more of a data structure associated with said device and said system data structure and enabling the transfer of at least a portion of said value between said device data structure to one or more of said terminal or network.

The system and method may include displaying an active poster at a terminal representing an event including one or more of a promotion, service, game or information. For example the terminal may include an electronic display to display an active poster. In response to a user registering their portable device into the NFC network associated with the poster or touching the poster to activate the NFC, one of the device display and panel are controlled to display a visual indication of communication of event data between said terminal and said device. The indication may be a message with a color background, logo, icon or other graphic to indicate that the device has interacted with the near field communication network associated with the poster. As but an example, the panel may be controlled to a visual state indicating that a promotion has been accepted for later redemption.

As but another embodiment the system and method may include a user input at one or more of the device and terminal by which the user can control the visual aspects of the panel. For example, where the panel represents a surface of a smart card the user may control the panel to a pattern, color, or graphic as desired or as selected from an offered menu.

In a specific embodiment the system and method are directed to a casino player system. The players are provided with portable devices and/or their own devices are configured to provide for near field communication with gaming machines or devices, including portable gaming devices. The portable device may include a data structure storing player loyalty points and a value amount at least a portion of which is available or accessible to the player for wagering. Each device includes a display such as an e-ink, OLED, cholesteric LCD or other display. A portion of the display and/or a separate visually configurable panel are controllable to display a visual indication such as a color, pattern, graphics, visual presentation or a combination to which the player can refer to identify an attribute reflecting a condition of the player's relationship to system defined criteria. For example the panel may display one or more of a color reflecting the player's loyalty club level or tier, saved state(s) for a gaming machine, available or accepted promotions, value amounts available for gaming, and self-exclusion condition(s) or the like. In an embodiment the portable device can be configured to enable the user to select options. The selection of the options may result in the panel changing its visual presentation. For example the player may make selections to identify different games whereupon the panel changes its visual presentation to indicate a saved state condition for each game. The method and system may also control the panel to change its visual presentation based upon the environment. For example, where the player is at Casino A, interfacing their portable device with a terminal, may control the panel to assume a color condition indicating the player is a silver tier player at that casino. If the player goes to neighboring but affiliated Casino B and places their card in a terminal NFC, the panel may be controlled to a display a color of gold indicating that the player is a first tier player at Casino B.

To secure the device the system and method may require the player to provide personal data or biometric information to activate, change or update the device and system. In an embodiment the player has a personal identification number (PIN) and one or more of the device and terminal includes an input device to enable the player to input the PIN to “unlock” the communication link between the device and the terminal and network.

Other features and numerous advantages of the various embodiments will become apparent from the following detailed description when viewed in conjunction with the corresponding drawings.

### BRIEF DESCRIPTION OF THE DRAWINGS

These and other features and advantages will become better understood with reference to the specification claims and drawings wherein;

FIG. 1 illustrates an example of a gaming terminal of the type compatible with the systems and methods of the present invention;

FIGS. 2A and 2B illustrates a functional diagram of the components of a gaming terminal of FIG. 1;

FIG. 3 is a block diagram of the logical components of a gaming kernel for the gaming terminal;

FIGS. 4A and 4B illustrates a diagram of a system configurable according to the systems and methods of the present invention;

FIG. 5 illustrates aspects a smart card according to the prior art;

FIG. 6 illustrates a gaming terminal and various portable devices according to embodiments of the present invention;

FIG. 7 illustrates a system interface device for the gaming terminal to provide communication between the terminal and the system;

FIG. 8 illustrates a portable device smart card according to embodiments of the invention;

FIG. 9 illustrates the several components of the smart card of FIG. 8;

FIG. 10 illustrates a menu which may be displayed at the gaming machine for a player to select a value to transfer for wagering;

FIG. 11 is a process diagram for a game session process;

FIG. 12 is a process diagram showing a player promotion and acceptance process;

FIG. 13 is a process diagram showing use of the portable device smart card to begin a gaming session;

FIG. 14 is a process diagram showing synchronization between a portable smart card device and the system; and

FIG. 15 illustrates processes for terminating a gaming session at one casino and beginning a new session at another casino.

### DETAILED DESCRIPTION

A. Embodiment of a Gaming Terminal

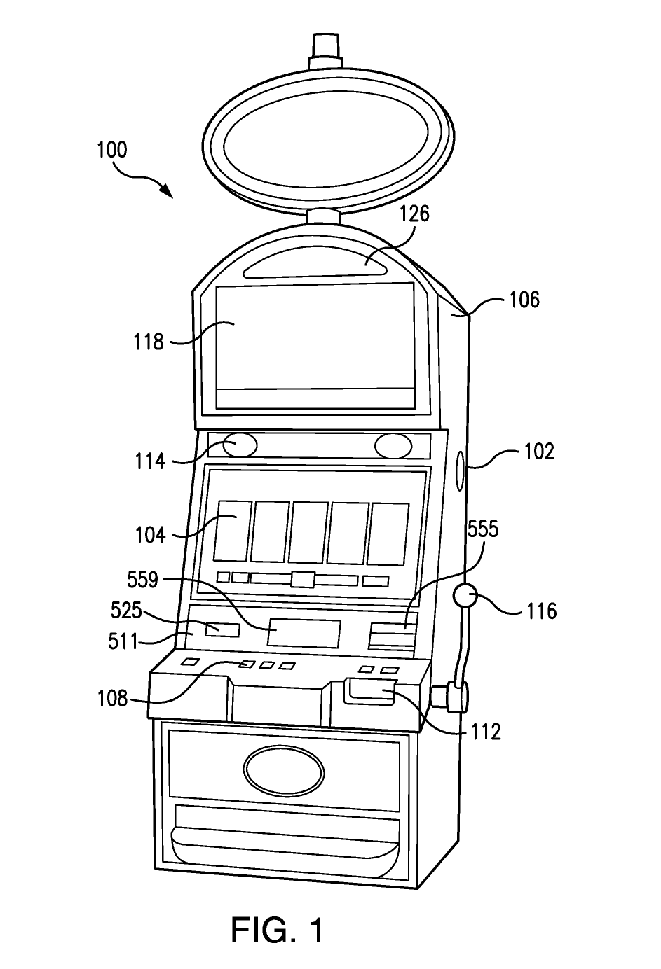

Referring now to the drawings, wherein like reference numbers denote like or corresponding elements throughout the drawings, and more particularly referring to FIG. 1, a gaming terminal 100 according to the prior art is shown. The gaming terminal 100 includes cabinet housing 102, primary game display 104 upon which a primary game and feature game may be displayed, top box 106 which may display multiple progressive prizes that may be won during play of the feature game, a game input device 108 shown as player-activated button panel, player tracking module 511 (such as a player tracking interface device sold by Bally Technologies, Inc as an iView® device), bill/voucher acceptor 112 and one or more speakers 114. The housing 102 may be a self-standing unit that is generally rectangular in shape and may be manufactured with reinforced steel or other rigid materials which are resistant to tampering and vandalism. The housing 102 may alternatively be a handheld device including the gaming functionality as discussed herein and including the various of the described components herein. For example, a handheld device may be a cell phone, personal digital assistant, or laptop or tablet computer, each of which may include or interface with a display, a processor, and memory sufficient to support either stand-alone capability such as gaming terminal 100 or thin client capability such as that incorporating some of the capability of a remote server.

In one or more embodiments, the housing 102 houses a processor, circuitry, and software (not shown) for receiving signals from the game input device 108, operating the games, and transmitting signals to the respective displays and speakers. Any shaped cabinet may be implemented with any embodiment of gaming terminal 100 so long as it provides access to a player for playing a game. For example, the cabinet 102 may comprise a slant-top, bar-top, or table-top style cabinet, including a Bally Cinevision™ or CineReels™ cabinet. The operation of gaming terminal 100 is described more fully below.

The plurality of player-activated buttons of the game input device 108 may be used for various functions such as, but not limited to, selecting a wager denomination, selecting a game to be played, selecting a wager amount per game, initiating a game, or cashing out money from gaming terminal 100. Buttons may be operable as input mechanisms and may include mechanical buttons, electromechanical buttons or touch screen buttons. Optionally, a handle 116 may be rotated by a player to initiate a game.

In one or more embodiments, the buttons if the game input device 108 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. Pub. 2006/0247047, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Housing 102 may optionally include the top box 106 which contains “top glass” 118 comprising advertising or payout information related to the game or games available on gaming terminal 100. The player tracking module 511 includes system interface configured to include a card reader 555 of the type for reading the magnetic stripe on a player loyalty card and communicating with the gaming system. As hereinafter described in accordance with the several embodiments of the present invention the system interface may include a near field communication (NFC) device for contactless communication with portable device such as a smart cart. A player tracking module display 559 is provided on the player tracking module 511 to display messages such as system generated messages to the players and to casino personnel. A voucher printer 525 may be integrated into the player tracking module 511 or installed elsewhere on the housing 102 or top box 106. Artwork 126 may complete the top box 106.

The glass 118 in the top box 106 may instead be a secondary electronic display to display game information, bonus games or the like.

The primary game display 104 typically presents a game of chance wherein a player receives one or more outcomes from a set of potential outcomes. For example, one such game of chance is a video slot machine game. In other aspects of the invention, gaming terminal 100 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include terminal displays such as mechanical reels, wheels, or dice as required to present the game to the player. In video/mechanical or pure video embodiments, the primary game display 104 is, typically, a CRT or a flat-panel display in the form of, but not limited to, liquid crystal, plasma, electroluminescent, OLED, vacuum fluorescent, field emission, or any other type of panel display known or developed in the art. The primary game display 104 may be mounted in either a “portrait” or “landscape” orientation and be of standard or “widescreen” dimensions (i.e., a ratio of one dimension to another of at least 16:9). For example, a widescreen display may be 32 inches wide by 18 inches tall. A widescreen display in a “portrait” orientation may be 32 inches tall by 18 inches wide. Additionally, primary game display 104 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571 entitled “Gaming Device with Direction and Speed Control of Mechanical Reels Using Touch Screen,” which is hereby incorporated by reference. Where the primary game display 104 is oriented in a portrait mode it may define both the primary game display 108 as well as the glass 118 where it creates a secondary game display.

The primary game display 108 may also present information such as, but not limited to, player information, advertisements and casino promotions, graphic displays, news and sports updates, or even offer an alternate game. This information may be generated through a host computer networked with gaming terminal 100 on its own initiative or it may be obtained by request of the player using an input device for example embodied as either one or more of the plurality of player-activated touch screen buttons at the primary game display 104 or buttons/icons located on the player tracking module 511 (shown in FIG. 7).

While the primary embodiments of the present invention are described with reference to gaming terminals and a player tracking loyalty and banking system, it should be understood that many aspects could be used in other environments such as customer loyalty programs for retailers, airline frequent flyer programs, banking, Internet commerce or the like. In instances other than gaming the terminals would be kiosks, check-out terminals or portable devices.

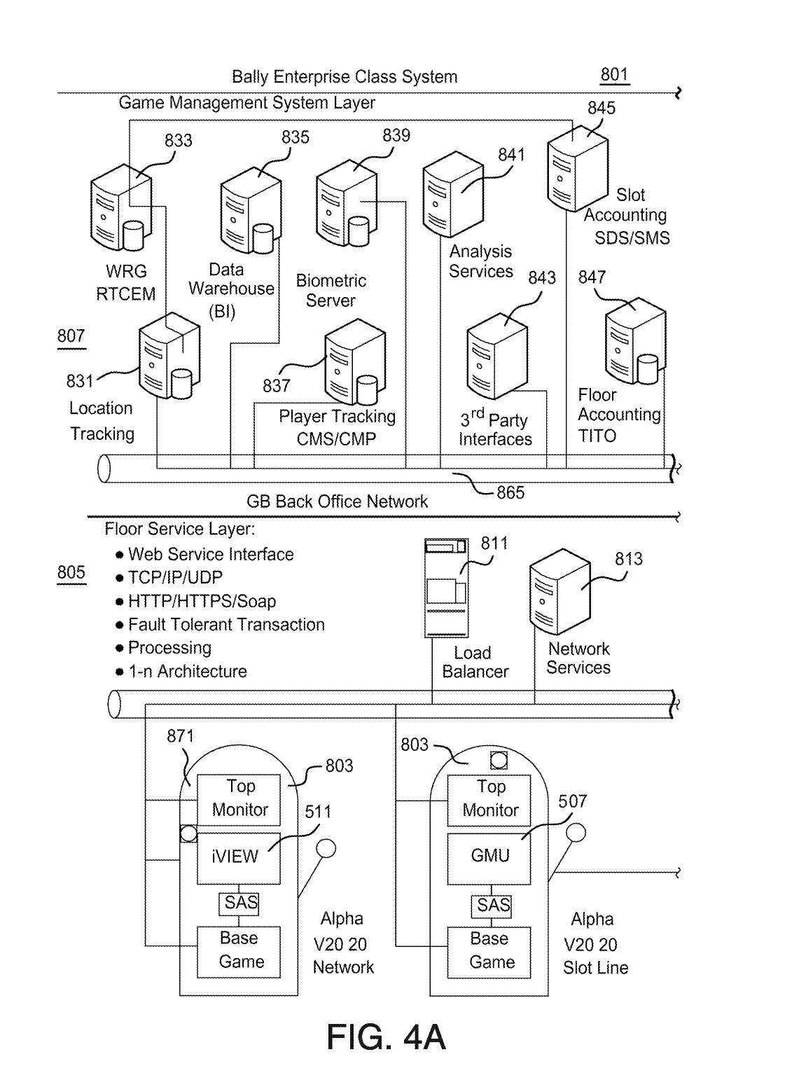

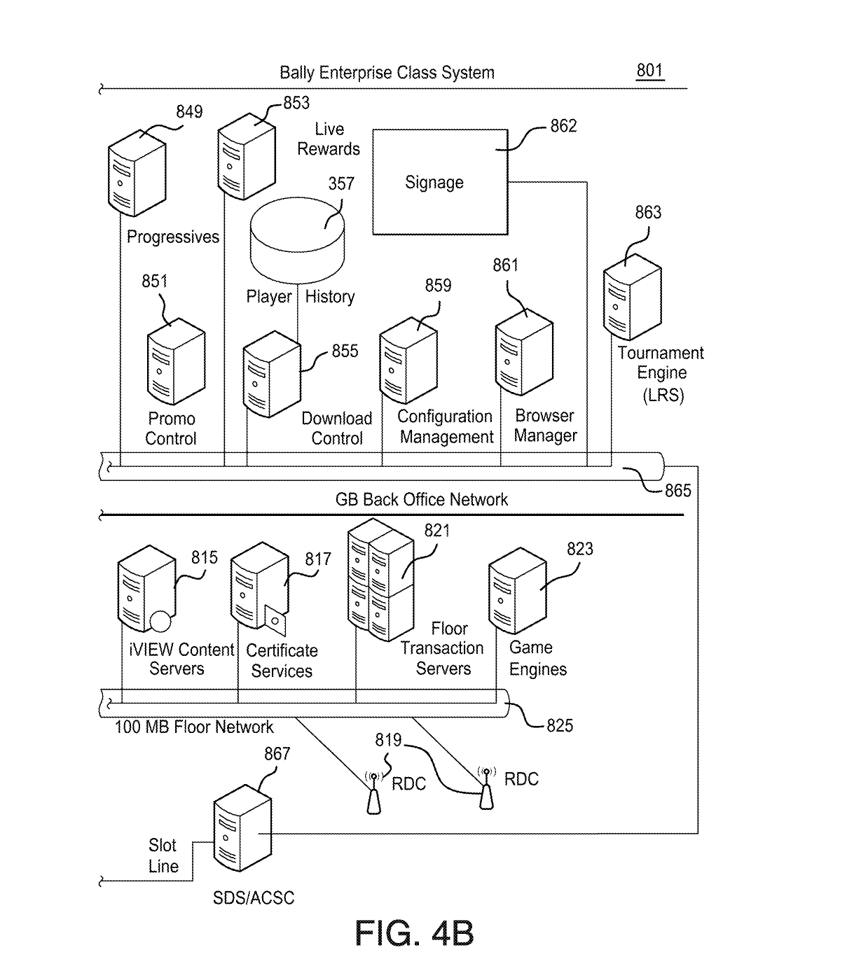

The gaming terminal 100 (shown as one or more gaming terminals 832) is typically included in a gaming system 830 as will hereinafter be described with reference to FIG. 4. The environment may be a single casino at a single geographic location or it may be several casino venues at different locations.

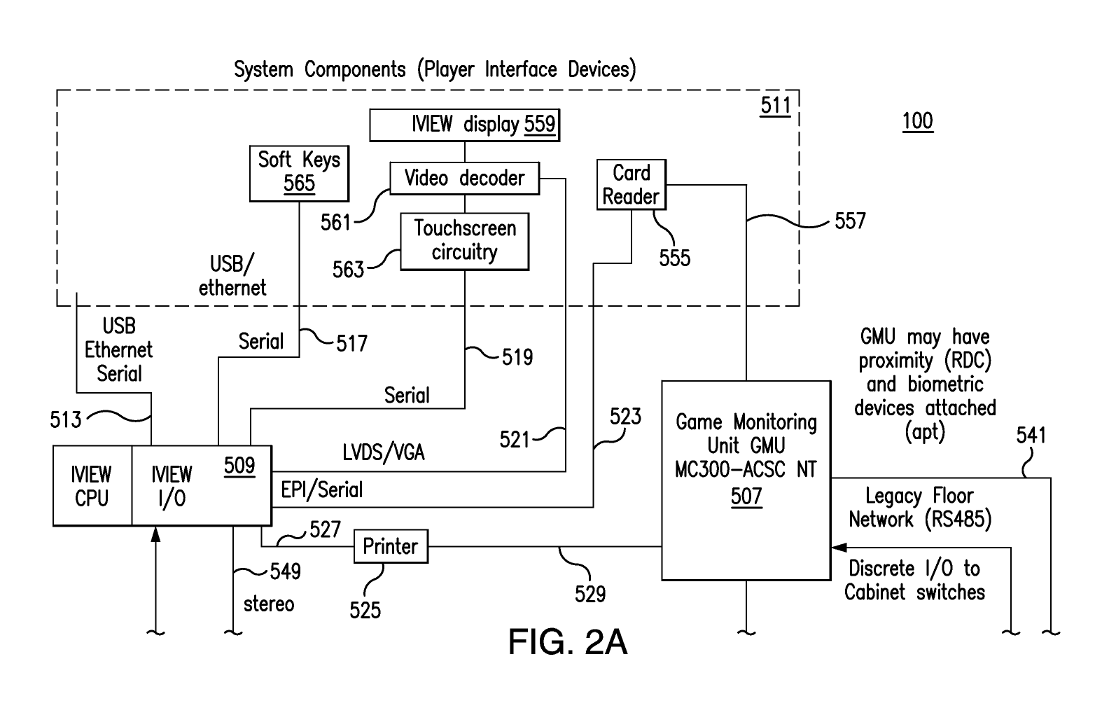

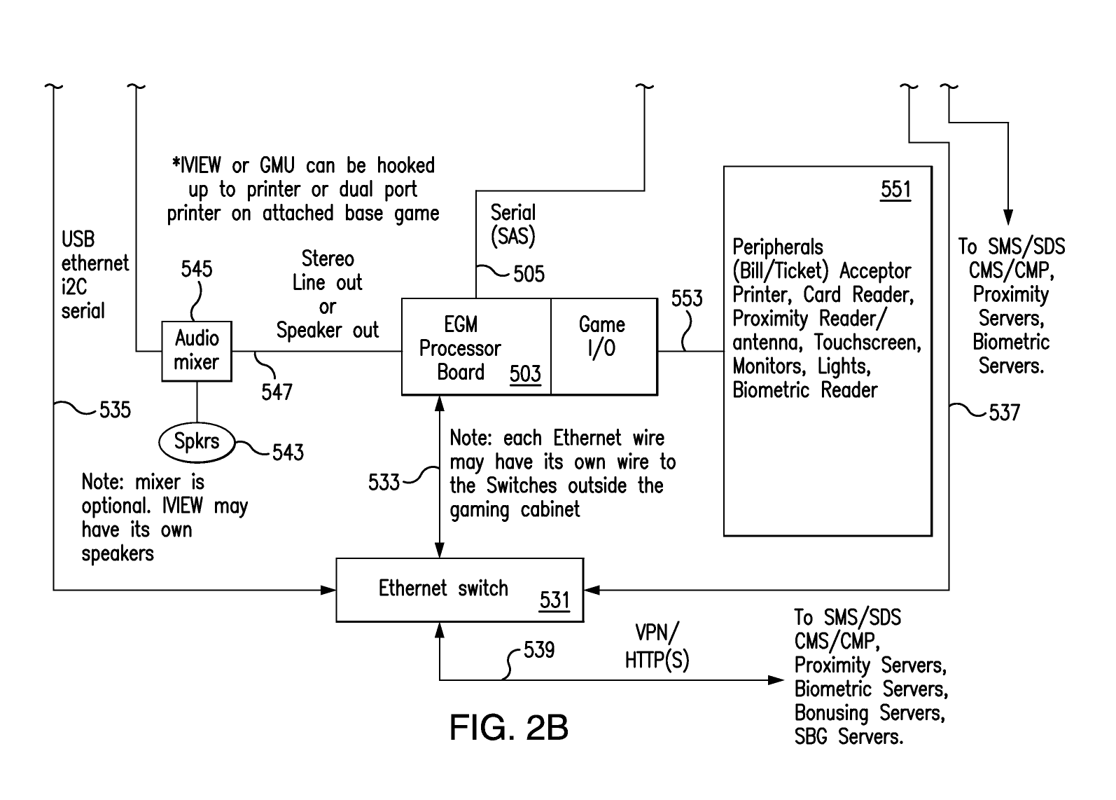

Referring to FIGS. 2A, B, the gaming terminal 100 hardware 501 for their controller(s) is shown in accordance with one or more embodiments. The hardware 501 includes base game integrated circuit board 503 (EGM Processor Board) connected through serial bus line 505 to game monitoring unit (GMU) 507 (such as a Bally MC300 or ACSC NT), and player interface integrated circuit board (PIB) 509 connected to a player tracking module (PTM) 511 over bus lines 513, 517, 519, 521, 523. The PTM 511 provides for communication between the gaming terminals and the system 830. Inasmuch as gaming terminals 100 may be manufactured by different entities, mounting like PTMs 511 at each gaming terminal 100 provides for communication to the system in one or more common message protocols. Gaming voucher ticket printer 525 (for printing player cash out tickets) is connected to PIB 509 and GMU 507 over bus lines 527, 529. EGM Processor Board 503, PIB 509, and GMU 507 connect to Ethernet switch 531 over bus lines 533, 535, 537. Ethernet switch 531 connects to a slot management system and a casino management system (SMS, SDS, CMS and CMP) 830 (FIG. 4) network over bus line 539. Ethernet switch 531 may also connect to a server based gaming server or a downloadable gaming server. GMU 507 also may connect to the network over bus line 541. Speakers 543 to produce sounds related to the game or according to the present invention connect through audio mixer 545 and bus lines 547, 549 to EGM Processor Board 503 and PIB 509.

Peripherals 551 connect through bus 553 to EGM Processor Board 503. The peripherals 551 include, but are not limited to the following and may include individual processing capability: bill/voucher acceptor 112 to validate and accept currency and ticket vouchers, communication component 120, the player interfaces such a buttons 108, displays 104 and any secondary or tertiary displays (with/without) touch screen functionality, monitors and lights. For example, the bill/voucher acceptor 112 is typically connected to the game input-output board of the EGM processing board 503 (which is, in turn, connected to a conventional central processing unit (“CPU”) board), such as an Intel Pentium® microprocessor mounted on a gaming motherboard. The I/O board may be connected to CPU processor board by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 503 executes a game program that causes the gaming terminal 100 to display and play a game. The various components and included devices may be installed with conventionally and/or commercially available components, devices, and circuitry into a conventional and/or commercially available gaming terminal housing 102.

When a player has inserted a form of currency such as, for example and without limitation, paper currency, coins or tokens, cashless tickets or vouchers, electronic funds transfers or the like into the currency acceptor, a signal is sent by way of bus 553 to the I/O board and to EGM processor board 503 which, in turn, assigns an appropriate number of credits for play in accordance with the game program. The player may further control the operation of the gaming machine by way of other peripherals 551, for example, to select the amount to wager via the player input device 108. The game starts in response to the player operating a start mechanism such as the handle 116, button such as a SPIN/RESET button or a touch screen icon. The game program includes a random number generator to provide a display of randomly selected indicia on one or more displays such as the primary game display 104 as shown in FIG. 1. In some embodiments, the random generator may be physically separate from gaming terminal 100; for example, it may be part of a central determination host system which provides random game outcomes to the game program. Finally, EGM processor board 503 under control of the game program and OS compares the final display of indicia to a pay table. The set of possible game outcomes may include a subset of outcomes related to the triggering of a feature or bonus game. In the event the displayed outcome is a member of this subset, EGM processor board 503, under control of the game program and by way of I/O Board 503, may cause feature game play to be presented on the primary game display 104 and/or any secondary display(s).

Predetermined payout amounts for certain outcomes, including feature game outcomes, are stored as part of the game program. Such payout amounts are, in response to instructions from processor board 503, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 507 includes an integrated circuit board and GMU processor and memory including coding for network communications, such as the G2S (game-to-system) protocol from the Gaming Standards Association, Las Vegas, Nev., used for system communications over the network. As shown, GMU 507 may connect to a card reader 555 (shown as 120 in FIG. 1) through bus 557 and may thereby obtain player information and transmit the information over the network through bus 541. Gaming activity information may be transferred by the EGM Processor Board 503 to GMU 507 where the information may be translated into a network protocol, such as S2S, for transmission to a server, such as a player tracking server, where information about a player's playing activity may be stored in a designated server database.

PID 509 includes an integrated circuit board, PID processor, and memory which includes an operating system, such as Windows CE, a player interface program which may be executable by the PID processor together with various input/output (I/O) drivers for respective devices which connect to PID 509, such as player tracking module 511, and which may further include various games or game components playable on PID 509 or playable on a connected network server and PID 509 is operable as the player interface. PID 509 connects to card reader 555 through bus 523, player tracking display 559 through video decoder 561 and bus 521, such as an LVDS or VGA bus.

As part of its programming, the PID processor executes coding to drive player tracking display 559 and provide messages and information to a player. Touch screen circuitry 563 interactively connects display 559 and video decoder 561 to PID 509 such that a player may input information and cause the information to be transmitted to PID 509 either on the player's initiative or responsive to a query by PID 509. Additionally soft keys 565 connect through bus 517 to PID 509 and operate together with the player tracking display 559 to provide information or queries to a player and receive responses or queries from the player. PID 509, in turn, communicates over the CMS/SMS network through Ethernet switch 531 and busses 535, 539 and with respective servers, such as a player tracking server.

Player tracking devices 511 are linked into the virtual private network of the system components in gaming terminal 100. The system components include the player tacking module 511 (e.g. Bally iVIEW® device) (‘iView” is a registered trademark of Bally Gaming, Inc.) processing board 503 and game monitoring unit (GMU) processing board 507. These system components may connect over a network to the slot management system (such as a commercially available Bally SDS/SMS) and/or casino management system (such as a commercially available Bally CMP/CMS).

The GMU 507 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the PTM 511 processing board and game monitoring unit (GMU) processing board 507. The GMU 507 and PTM 511 can be combined into one like the commercially available Bally GTM iVIEW device. This device may have a video mixing technology to mix the EGM processor's video signals with the iVIEW display onto the top box monitor or any monitor on the gaming device.

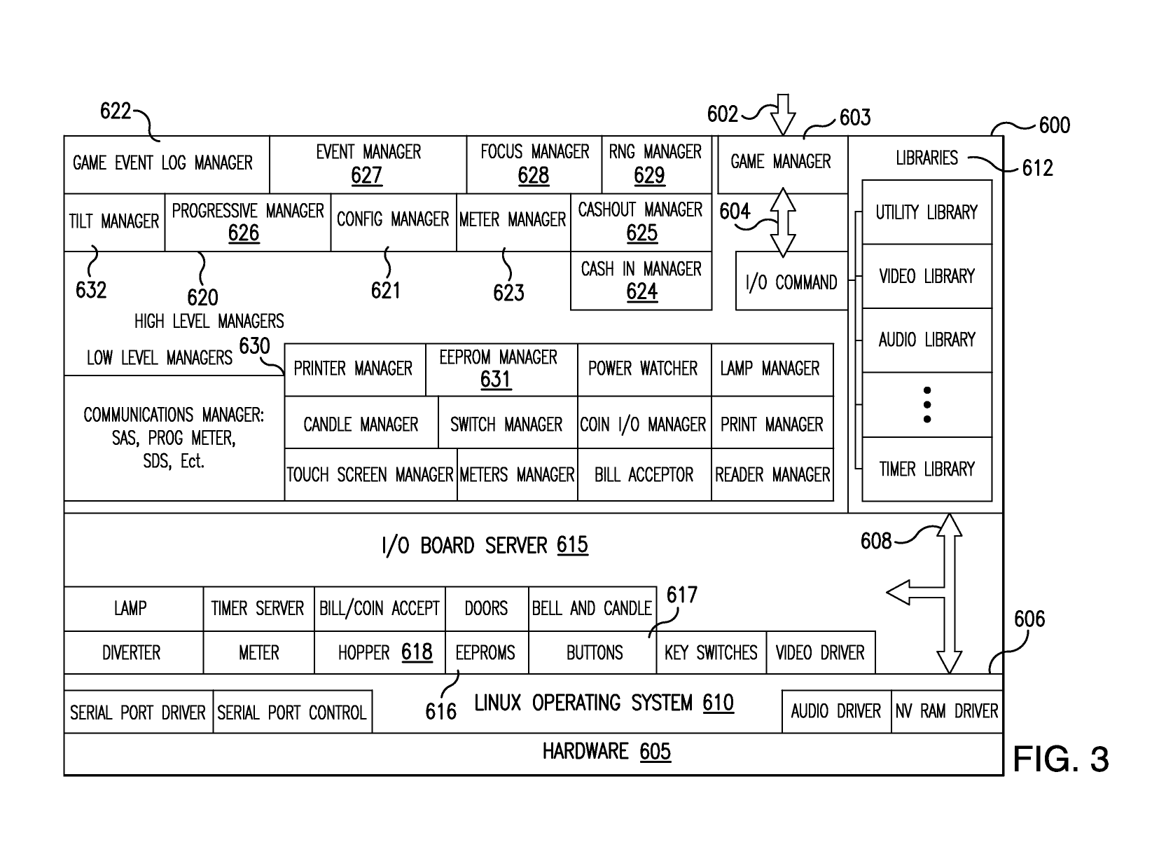

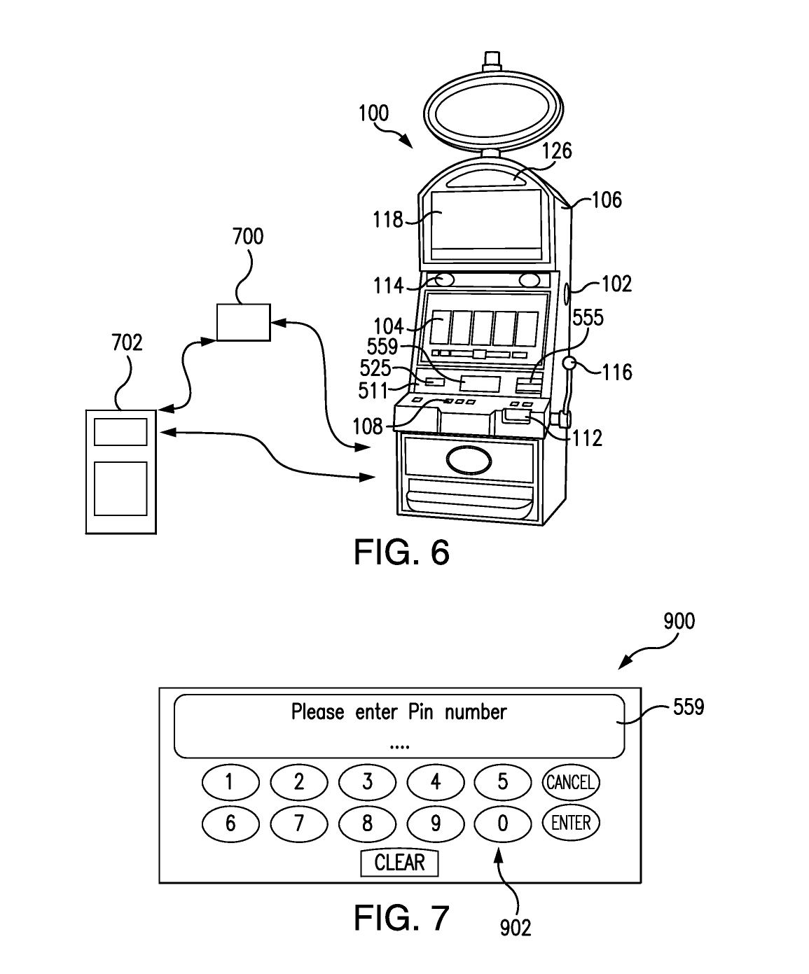

In accordance with one or more embodiments, FIG. 3 is a functional block diagram of a gaming kernel 600 of a game program under control of gaming terminal processor board 503. The game program uses gaming kernel 600 by calling into application programming interface (API) 602, which is part of game manager 603. The components of game kernel 600 as shown in FIG. 6 are only illustrative, and should not be considered limiting. For example, the number of managers may be changed, additional managers may be added or some managers may be removed without deviating from the scope and spirit of the invention.

As shown in the example, there are three layers: a hardware layer 605; an operating system layer 610, such as, but not limited to, Linux; and a game kernel layer 600 having game manager 603 therein. In one or more embodiments, the use of an operating system layer 610, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 600 executes at the user level of the operating system layer 610, and itself contains a major component called the I/O board server 615. To properly set the bounds of game application software (making integrity checking easier), all game applications interact with gaming kernel 600 using a single API 602 in game manager 603. This enables game applications to make use of a well-defined, consistent interface, as well as making access points to gaming kernel 600 controlled, where overall access is controlled using separate processes.

For example, game manager 603 parses an incoming command stream and, when a command dealing with I/O comes in (arrow 604), the command is sent to an applicable library routine 612. Library routine 612 decides what it needs from a device, and sends commands to I/O board server 615 (see arrow 608). A few specific drivers remain in operating system layer 610's kernel, shown as those below line 606. These are built-in, primitive, or privileged drivers that are (i) general (ii) kept to a minimum and (iii) are easier to leave than extract. In such cases, the low-level communications is handled within operating system layer 610 and the contents passed to library routines 612.

Thus, in a few cases library routines may interact with drivers inside operating system layer 610, which is why arrow 608 is shown as having three directions (between library routines 612 and I/O board server 615, or between library routines 612 and certain drivers in operating system layer 610). No matter which path is taken, the logic needed to work with each device is coded into modules in the user layer of the diagram. Operating system layer 610 is kept as simple, stripped down, and common across as many hardware platforms as possible. The library utilities and user-level drivers change as dictated by the game cabinet or game machine in which it will run. Thus, each game cabinet or game machine may have an industry standard EGM processing board 503 connected to a unique, relatively dumb, and as inexpensive as possible I/O adapter board 540, plus a gaming kernel 600 which will have the game-machine-unique library routines and I/O board server 615 components needed to enable game applications to interact with the gaming machine cabinet. Note that these differences are invisible to the game application software with the exception of certain functional differences (i.e., if a gaming cabinet has stereo sound, the game application will be able make use of API 602 to use the capability over that of a cabinet having traditional monaural sound).

Game manager 603 provides an interface into game kernel 600, providing consistent, predictable, and backwards compatible calling methods, syntax, and capabilities by way of game application API 602. This enables the game developer to be free of dealing directly with the hardware, including the freedom to not have to deal with low-level drivers as well as the freedom to not have to program lower level managers 630, although lower level managers 630 may be accessible through game manager 603's interface 602 if a programmer has the need. In addition to the freedom derived from not having to deal with the hardware level drivers and the freedom of having consistent, callable, object-oriented interfaces to software managers of those components (drivers), game manager 603 provides access to a set of upper level managers 620 also having the advantages of consistent callable, object-oriented interfaces, and further providing the types and kinds of base functionality required in casino-type games. Game manager 603, providing all the advantages of its consistent and richly functional game application API 602 as supported by the rest of game kernel 600, thus provides a game developer with a multitude of advantages.

Game manager 603 may have several objects within itself, including an initialization object (not shown). The initialization object performs the initialization of the entire game machine, including other objects, after game manager 603 has started its internal objects and servers in appropriate order. In order to carry out this function, the kernel's configuration manager 621 is among the first objects to be started; configuration manager 621 has data needed to initialize and correctly configure other objects or servers.

The high level managers 620 of game kernel 600 may include game event log manager 622 which provides, at the least, a logging or logger base class, enabling other logging objects to be derived from this base object. The logger object is a generic logger; that is, it is not aware of the contents of logged messages and events. The game event log manager's 622 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 623 manages the various meters embodied in the game kernel 600. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 623 receives its initialization data for the meters, during start-up, from configuration manager 621. While running, the cash in manager 624 and cash out manager 625 call the meter manager's 623 update functions to update the meters. Meter manager 623 will, on occasion, create backup copies of the soft meters by storing the soft meters' readings in EEPROM. This is accomplished by calling and using EEPROM manager 631.

In accordance with still other embodiments, progressive manager 626 manages progressive games playable from the game machine. Event manager 627 is generic, like game event log manager 622, and is used to manage various gaming machine events. Focus manager 628 correlates which process has control of various focus items. Tilt manager 632 is an object that receives a list of errors (if any) from configuration manager 621 at initialization, and during game play from processes, managers, drivers, etc. that may generate errors. Random number generator manager 629 is provided to allow easy programming access to a random number generator (RNG), as a RNG is required in virtually all casino-style (gambling) games. Random number generator manager 629 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 625 has the responsibility of configuring and managing monetary output devices. During initialization, cash out manager 625, using data from configuration manager 621, sets the cash out devices correctly and selects any selectable cash out denominations. During play, a game application may post a cash out event through the event manager 627 (the same way all events are handled), and using a call back posted by cash out manager 625, cash out manager 625 is informed of the event. Cash out manager 625 updates the credit object, updates its state in non-volatile memory, and sends an appropriate control message to the device manager that corresponds to the dispensing device. As the device dispenses dispensable media, there will typically be event messages being sent back and forth between the device and cash out manager 625 until the dispensing finishes, after which cash out manager 625, having updated the credit manager and any other game state (such as some associated with meter manager 623) that needs to be updated for this set of actions, sends a cash out completion event to event manager 627 and to the game application thereby. Cash in manager 624 functions similarly to cash out manager 625, only controlling, interfacing with, and taking care of actions associated with cashing in events, cash in devices, and associated meters and crediting.

In a further example, in accordance with one or more embodiments, I/O board server 615 may write data to the gaming machine EEPROM memory, which is located in the gaming machine cabinet and holds meter storage that must be kept even in the event of power failure. Game manager 603 calls the I/O library functions to write data to the EEPROM. The I/O board server 615 receives the request and starts a low priority EEPROM thread 616 within I/O board server 615 to write the data. This thread uses a sequence of 8 bit command and data writes to the EEPROM device to write the appropriate data in the proper location within the device. Any errors detected will be sent as IPC messages to game manager 603. All of this processing is asynchronous.

In accordance with one embodiment, button module 617 within I/O board server 615, polls (or is sent) the state of buttons every 2 ms. These inputs are debounced by keeping a history of input samples. Certain sequences of samples are required to detect a button was pressed, in which case the I/O board server 615 sends an inter-process communication event to game manager 603 that a button was pressed or released. In some embodiments, the gaming machine may have intelligent distributed I/O which debounces the buttons, in which case button module 617 may be able to communicate with the remote intelligent button processor to get the button events and simply relay them to game manager 603 via IPC messages. In still another embodiment, the I/O library may be used for pay out requests from the game application. For example, hopper module 618 must start the hopper motor, constantly monitor the coin sensing lines of the hopper, debounce them, and send an IPC message to the game manager 603 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

B. System

Referring to FIGS. 4A and B, a gaming system 801 is shown in accordance with one or more embodiments. Gaming system 801 may include one casino or multiple locations and generally includes a network of gaming terminals 803 (such as a gaming terminals 100 as described in FIG. 1), floor management system (SMS) 805, and casino management system (CMS) 807. SMS 805 may include load balancer 811, network services server 813, player tracking module 511, iView (PTM 511) content servers 815, certificate services server 817, floor radio dispatch receiver/transmitters (RDC) 819, floor transaction servers 821 and game engines 823 (where the gaming terminals 803 operate server based or downloadable games), each of which may connect over network bus 825 to gaming terminals 803. CMS 807 may include location tracking server 831, WRG RTCEM server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming machines 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming machines 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming machine. The GMU 507 has a connection to the base game through a serial SAS connection. The system components in the gaming cabinet may be connected to the servers using HTTPs or G2S over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming devices 803 are authenticated using conventional techniques prior to install on the system components.

In various embodiments, any of the gaming terminals 803 may be a mechanical reel spinning slot machine, video slot machine, video poker machine, video bingo machine, keno machine, or a gaming device offering one or more of the above described games including an interactive wheel feature. Alternately, gaming terminals 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions and the like. As is known in the industry and according to the prior art, at enrollment the player is assigned a created account in the player tracking CMS/CMP server 837 and is issued a player tracking card having a machine readable magnetic stripe. At enrollment the player may also be assigned to a “tier” level. For example, the casino or casino network may have a 3-tier player reward system labeling the tiers as, for example, a Silver Tier (Tier 1), a Gold Tier (Tier 2) and a Platinum Tier (Tier 3). These tier discriminators reflect a relative value of the player to the casino and are used to determine the type, nature and quantity of marketing and rewards offered to players. For example, at initial enrollment a player may be assigned into the Silver Tier and be entitled, based upon their commercial activity (wagering, purchases of goods/services) to certain rewards such as 2-for-1 show tickets, 2-for-1 buffet and the like. Through their commercial activity and over time the player may be viewed as a more valuable player and be “upgraded” to the Gold Tier where they receive more valuable rewards. The Platinum Tier is for the casino's most highly valued players. Rewards for the Platinum Tier would be more valuable. These promotions, according to the present invention, as well as player funds and other data are stored at, for example, the system server 853. The venue can update the promotions manually or via promotions configured and launched according to predetermined criteria. As but an example, the casino may configure a promotion to provide $25 in bonus play to Silver tier players, $30 to Gold tier players and $50 to Platinum tier players to become effective each Wednesday of the month between 1 pm and 8 pm to attract play during normally slow periods.

When a player plays a gaming terminal 100, he/she inserts their player tracking card into the card reader 555 (FIG. 2A) which communicates data to the CMS/CMP server 837 to accumulate loyalty points based upon the wagers/wins of the player. For example, a player may accumulate one loyalty point for each $5 wagered.

The system 801 may also include electronic transfer of funds functionality. For example, a player having accumulated $100 at a gaming terminal 100 may decide to “cash out” to play another gaming terminal. The player, for example using the player tracking module 511 to initiate communication with the system 801 for example server 837 to upload the value from the gaming terminal 100 into an electronic account associated with the player's account. The player may choose to upload all or a portion of the funds. The system would prompt the player to enter their PIN (or obtain biometrical confirmation as to the player's identity) and upload the chosen amount to their account. When the player moves to another gaming terminal 100 he/she inserts their player loyalty card into the card reader 555 to access their account. A prompt provides for the player to request funds from their account. Entering their PIN (or biometric identifier) the player can input the desired amount which is downloaded to their gaming terminal 100 for play.

While the above description has focused upon a system for the casino industry, it should be understood that systems for other industries such as airline frequent flyer programs and retail loyal programs operate functionally more or less as described.

C. Smart Card (Prior Art)

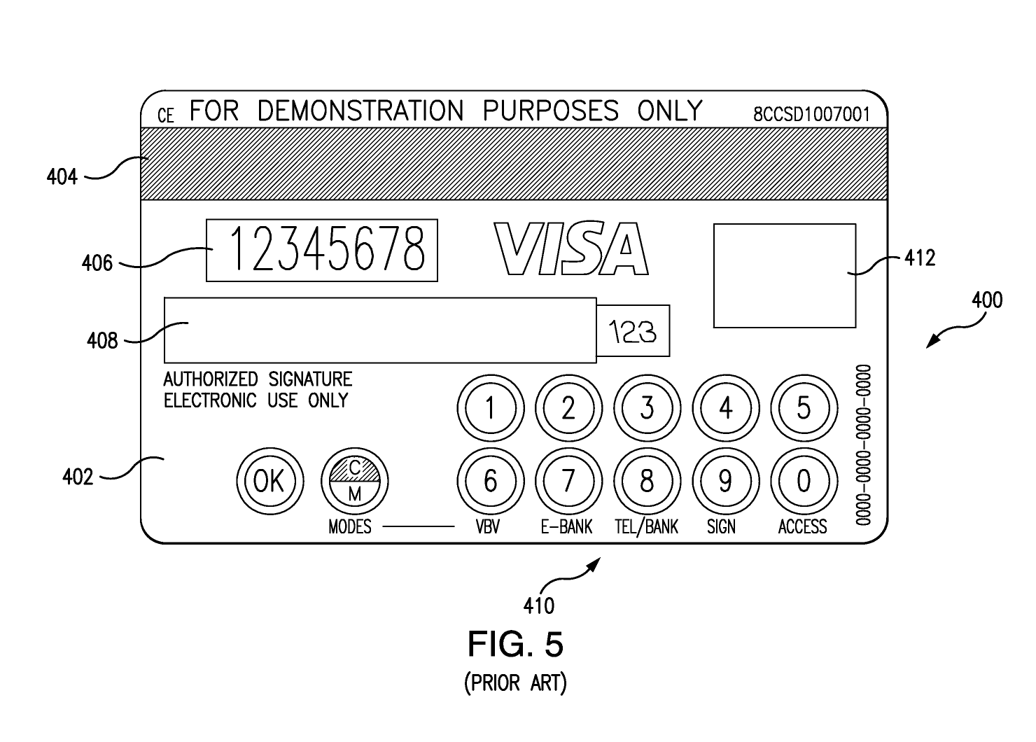

Turning now to FIG. 5 there is a shown an example of a prior art smart card 400 portable device. The smart card 400 is approximately the size of a common credit/debit card having front and back surfaces (only back surface 402 is shown). The front surface (not shown) may include embossed/printed graphics, the issuer's name as well as the cardholder's name and account number as is typical with a credit card. The back surface 402 includes a writable magnetic stripe 404, a small alpha-numeric display 406, a signature strip 408 where the user signs their card for signature verification and a plurality of buttons 410. A holographic image 412 is included to frustrate counterfeiting the smart card 400. The front and back surfaces may present a solid color or non-changeable printed or embossed graphics. Cards such as the on shown in FIG. 5 are available from E Ink Corporation, 733 Concord Ave., Cambridge, Mass. 02138. The display 406 is electronic paper (EFP—electrophoretic display) built-in when the card 400 is manufactured. The card includes an embedded processor, memory and near field antenna as is known in the art. The buttons 410 may be used to activate the card 400 (turn it on and off) and input, for example, a personal identification number (PIN) to activate the display 406 or execute a transaction. The card 400 may be manufactured according to prevailing ISO (International Organization for Standardization) prevailing standards such as ISO/IEC 15693-2:2006—Identification Cards—Contactless Integrated Circuit Cards—Vicinity Cards.

Inasmuch as such cards 400 are intended to retain secure information, unless activated the display 406 is blank and the card 400 is in a passive state, i.e. is not engaged in commercial intercourse with a near field based network/system. To prevent tampering for example while the card is in the postal system in an envelope or in a person's wallet or purse, NFC can only be established if the user activates the card 400 for example by pressing an “ON” button in an NFC environment field. A user pulling the card 400 from their wallet would have no alterable visual indication concerning an aspect of the card 400 or its intended network. Where such cards are applied into a gaming environment it would be advantageous to provide addition visual cues to the player with/without activation of the card or interaction with the gaming system. In environments other than gaming, such cues would also be useful to user. These cues may relate to available promotions, the user's status, accepted and remaining available discounts or promotions, instant prizes or the like.

The same holds true for other portable devices such as cellular telephones and PDAs to name a few. While it is known to display data and to use a cellular telephone and like devices in a manner of a smart card, it would be advantageous to display one or more visual cues to users in a near field commercial, communication environment.

D. Apparatus, Systems and Methods of Present Invention

With reference to the various embodiments of the present invention there is shown at FIG. 6 a gaming terminal 100 (803 in FIG. 4A) of the type described above. The gaming terminal 100 is included in the gaming system 801 described above. The gaming system 801 communication network may be cable such as CAT 6 or CAT 7, fiber-optic or a wireless network. To provide communication between the gaming terminals 100 of various types and manufacture, each gaming terminal 100 includes a system interface embodied, for example, as the PTM 511. The provider of the gaming system 801 would typically provide the PTMs 511 for mounting in the gaming terminal housings 102, such as a PTM 511 device as an iView® device manufactured by Bally Technologies, Inc. of Las Vegas, Nev. As part of its list of functions, the PTM 511 interacts with the gaming machine GMU 507 and other components and peripherals as described herein and with selected servers and data bases of the network.

The user of the system and method is provided or is in possession of a portable device such as a smart card 700 (or cellular telephone 702, PDA or other electronic device). While the invention as hereinafter described assumes that the user has a smart card 700, other portable electronic devices could be used. In a preferred embodiment each gaming terminal 100 is provided with a near field communication transceiver of the type configured to communicate with the smart card 700 and/or cellular telephone 702 using near field communication protocols and techniques. In an embodiment the near field transceiver may be disposed in the PTM 511 or included elsewhere within the gaming terminal housing 102 such as the card reader 555. To accommodate legacy cellular telephones which may not include near field capability the smart card 700 may be configured to interact both with the cellular telephone and with the near field communication (NFC) transceiver. For example the smart card 700 may be configured to have a personal area network transceiver such as a Bluetooth transceiver to interact with the cellular telephone's Bluetooth transceiver and a near field communication (NFC) transceiver as disclosed in Loh, et al US Pub. 2009/0143104 titled “Wireless Smart Card and Integrated Personal Area Network, Near Field Communication and Contactless Payment System” the disclosure of which is incorporated by reference. The near field transceiver is preferably configured to RFID tag specifications such as ISO/IEC 14443. Accordingly when the smart card 700 is brought to within a distance of 0 (contact)-20 cm a current is induced in the smart card antenna to activate and enable the card to establish communication with the system and network. The contact/contactless NFC may be according to the VISA PAYWAVE® (a registered Trademark of Visa International Service Assn.) system. To avoid “snooping” of the smart cards 700 by unauthorized people seeking private information or to steal electronic funds accessible via the smart cards 700, the player must take active steps such as entering a PIN or the like to activate the card or initiate a communication or action. For example, in one embodiment, the player is required to “unlock” the smart card 700 and enter a PIN initially and periodically to establish and maintain communication with the NFC transceiver.

To facilitate interaction between the player and the system the PTM 511 may include a NFC interface device 900 as shown in FIG. 7. The device 900 may include the display 559 and a separate button panel 902. Alternatively the display 511 may have touch screen functionality to also display a touch screen button panel 902. When communication is established between the smart card 700, the player may be prompted to enter a PIN at the device 900 using the button panel to execute a transaction.

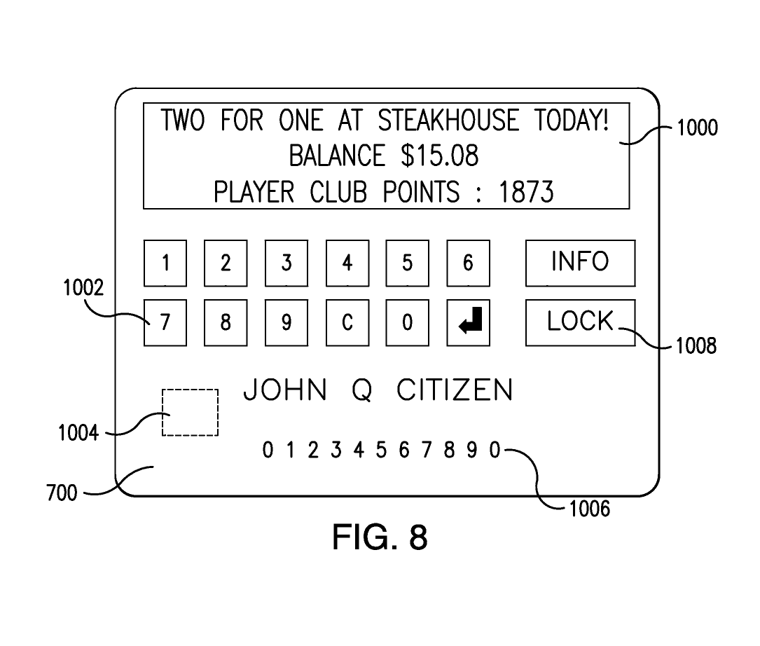

FIG. 8 illustrates one side, e.g. the back side, of the smart card 700 according to an embodiment of the present invention. The front side, not shown, may include printed/embossed graphics for example identifying the issuer/sponsor. The smart card 700 includes an on board memory (data structure) and CPU as hereinafter described as well as a display 1000 which may be an e-ink display (EFP—electrophoretic display or cholesteric display) as described above. The display 1000 is controlled to display alpha-numeric messages to the users of the type as hereinafter described. Briefly, and as suggested in FIG. 8, the messages may include promotion information, a balance in the player's electronic account as well as the number of player club (i.e. casino loyalty) points in the player's account. Other messages and greetings can also be displayed. Provided on the back side of the smart card 700 are a plurality of buttons 1002 such as twelve buttons labeled with numbers “0” through “9”, “C”, (go back/delete), “INFO”, and “LOCK” the functions of which will hereinafter become evident. Additionally all or a portion of the back surface of the smart card includes a panel 1004 which is configurable to assume one or more of a color, graphic or pattern or other visual presentation. The panel 1004 may encompass all of the unused area of the back of the smart card 700 or as shown may constitute a panel or window on the card. The panel may be an e-ink, electrophoretic display, or cholesteric display which preferably is a color display. The smart card 700 may also have the player's name and the player's account number 1006 printed or embossed on the back side. The display 1000 and panel 1004 may be in the front side and/or back side of the smart card 700 or on reverse sides. The panel 1004 is configurable and preferably at least a portion is persistent, i.e. operates in a display condition even when the smart card 700 is not within a NFC field or in a locked state.

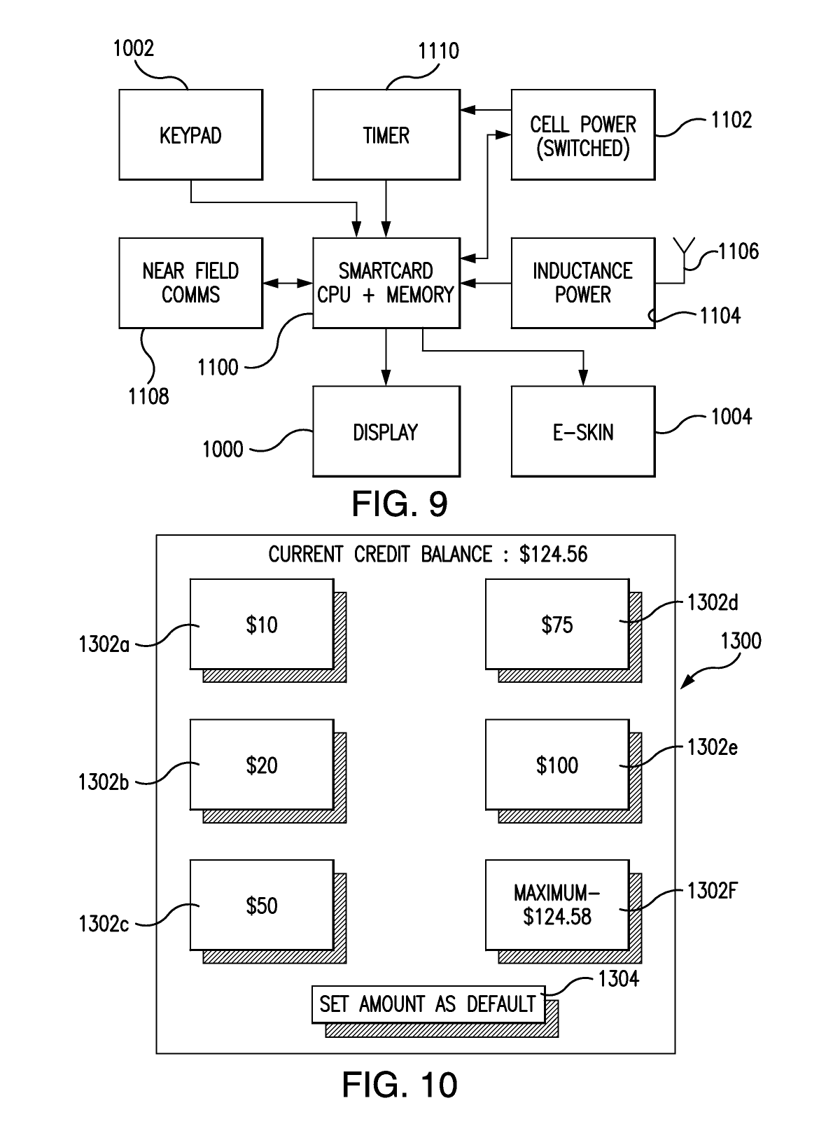

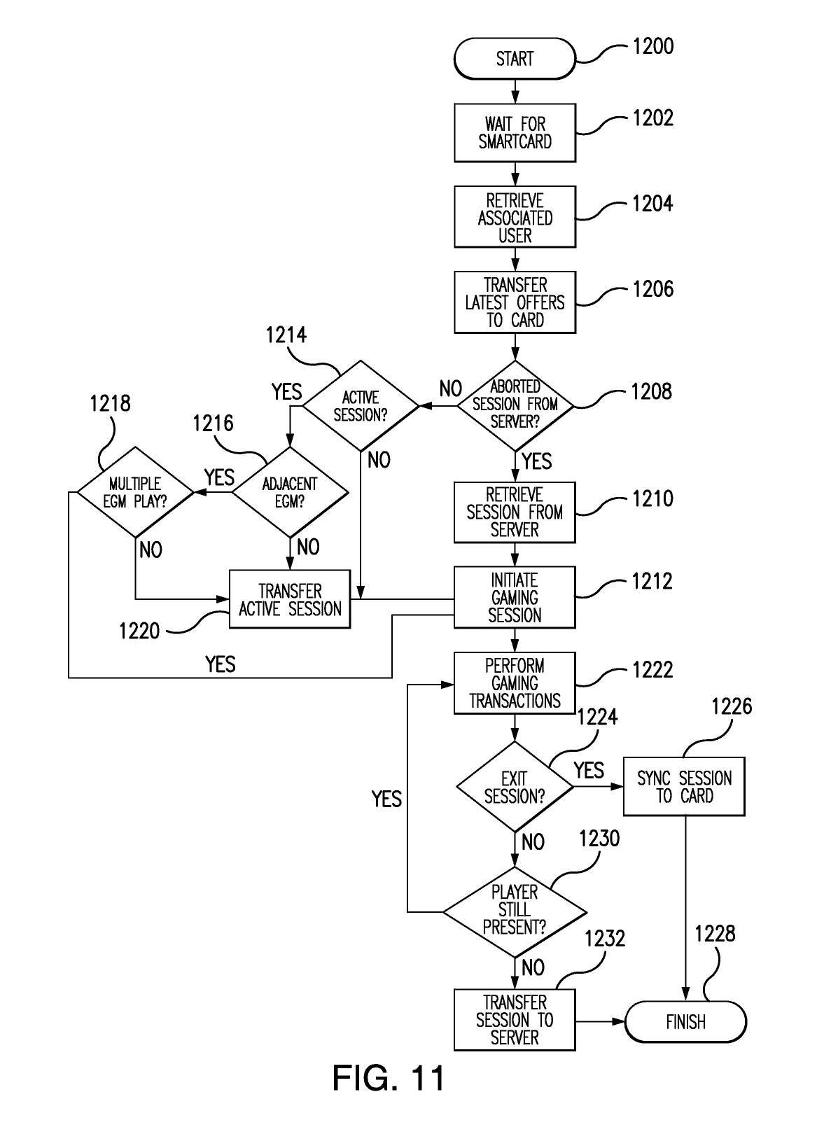

FIG. 9 illustrates an embodiment of the architecture of a smart card 700. The architecture and functions will be described with reference to FIG. 9 and FIG. 11. After enrolling into the system, such as for example at a casino loyalty program sign-up desk or kiosk, airline frequent flier desk or a chain retainer center, the user's account is established in the system and the user is issued the smart card 700. While enrollment may enable devices other than an issued smart card 700 such as the user's PDA or cellular telephone having NFC capability, it shall be assumed for the purposes of the description of this embodiment that the user requires an issued smart card 700. In those instances where the user has an electronic device with NFC compatibility, it may be necessary to configure the device to operate in the system, configure the user's account and to issue the enabling PIN. In those instances where the user's PDA or cellular telephone are not compatible with the NFC of the system, the user may be issued the smart card 700 which may interface between the system and the user's PDA or cellular telephone as suggested in Loh, et al US Pub. 2009/0143104 titled “Wireless Smart Card and Integrated Personal Area Network, Near Field Communication and Contactless Payment System” the disclosure of which has been incorporated by reference. Once the user's account has been established and the user has been issued the smart card 700 and PIN, the smart card 700 is first initialized, for example, at the enrollment center.

The smart card 700 includes an on-board CPU/memory 1100 configured to include an operating system and programming to operate the functions and components as hereinafter described. A battery 1102 provides an on-board power to maintain certain functions such as, where required, the panel 1004 in a displaying condition. An inductive power circuit 1104 with an antenna 1106 is configured to generate power when the smart card 700 is brought into an NFC field. When power is generated by the inductive power circuit 1104 the smart card 700 is powered up by the battery 1102. To render the smart card 700 functional the user may have to unlock the smart card 700 such as, for example, periodically depressing the lock button 1008 on the smart card 700 (FIG. 8) or on the PTM 511 or at the display 104 of the gaming terminal 100 and, if required, entering the player's PIN. As but an example, when the smart card 700 is powered up the smart card 700 near field communication module 1108 may issue a signal to the card reader 555 causing the system to issue a message or sound at the gaming terminal 100 (or PTM 511) to advise the user to unlock their smart card 700. Other components of the smart card 700 according to this embodiment include the display 1000, an e-skin panel 1004, the keypad 1002 and an internal clock or timer 1110.

At 1200 (FIG. 11) the system and NFC is initiated. This initialization may be when the system is first activated and hence would remain in an active state during operational hours of the casino. At 1202 the system and NFC waits for the presence of a smart card 700. When the smart card 700 is brought into the influence of a near field communication (NFC) field, the field via an antenna 1106, inductively powers the inductance power circuit 1104 which in turn powers certain electronics and displays of the smart card 700. The NFC field may be continuously generated at the gaming terminal 100 card reader 555 or may be selectively powered as by, for example, the player touching their smart card 700 to an icon, electronic poster or button on the gaming terminal 100, for example at the PTM 511 display 509 or a separate interface display such as primary game display 104. To actively power up, the user may have to unlock the smart card 700 as by pushing the “lock/unlock button” 1008. The user may unlock the smart card 700 upon entering the casino venue. In this fashion the card may not be inadvertently powered-up. The player may have to periodically unlock and enter their PIN to maintain communication or upon being prompted to do so. For example, after a period of inactivity the player may be prompted at a display or by an audible tone to re-activate their smart card 700. When the smart card is “powered up”, according to one embodiment, several operations take place. At 1204 communication is established between the card reader and the NFC Comm module 1108 on the smart card 700 to respond to the inquiry by the reader 555 to determine whether the smart cart 700 supports system communication. For example, if the smart card 700 is a bank issued smart card incompatible with the system, the process will terminate. If the smart card 700 is compatible, the smart card 700 transmits data to the reader 555 to associate the user with a system maintained user/player account. In this regard the user may be prompted to enter a PIN at the gaming terminal 100 or via the keypad 1002 on the smart card 700 or PTM 511 to establish the communications link and as a precursor to transmission of the user identification data. In addition to retrieving identification data from the smart card 700, the timer 1110 in the smart card 700 is synchronized with a system clock to the proper time and date to synchronize the active promotions and features available to the user.

At 1206 the system, via the NFC communications link, transfers to the smart card 700 NFC Comm Module 1108 and CPU/Memory 1100 the latest and most current data regarding the player's account such as current offers, current tier standing, loyalty points, electronic funds available and any other data as configured by the administrator. This transfer may be a transfer of data to overwrite exiting data or it may sync the system data with the data stored at the CPU/memory 1100, i.e. write or overwrite only the changed data. The channel for such communication is, preferably, encrypted such as by the use of an asymmetric key exchange. The promotions would be configured, for example, to be of a global nature (for all players), property specific, data specific, game specific, and tier specific and player specific promotions. These specific promotions may be related to a particular game, game title, player or the like. As but an example, the system would first retrieve and download to the card, applicable global offers such as those shown in Table 1 below.

TABLE 1

| | |
|---|---|
| March 1-7 | 2x Player Club Points for Slot Play |
| March 8-14 | Earn Entries in a $10,000 Drawing |
| March 15-21 | Half price Buffet |
| March 22-27 | Slot Tournament |

An example of game specific offers may be as listed in Table 2 below.

TABLE 2

| | |
|---|---|
| March 1-7 | 5 Free Spins During Bonus Feature on |
| | “Blazing Sevens” Game |
| March 8-14 | $50 Bonus For Level 2 Progressive on |
| | Any “Cherry Red” Game |
| March 15-21 | 2x Player Club Points for Video Poker |
| March 22-27 | $5 Match Play for Any 25 cent |
| | Denomination Game |

Specific offers may be related to a particular location (where the smart card 700 is operational across several locations such as across a family of related casinos) or at certain locations within a casino such as a sports bar or the like. The promotions may be to encourage certain types of wagering such as sports wagering or table games. Promotions may be configured to provide promotions based upon the tier level of the players as well. Based upon the system and smart card 700 timer 1110, certain promotions may have expired and would be culled from the list(s) of offerings or otherwise be made un-executable. The available offers would be downloaded or synched to the smart card 700 CPU/memory 1100.

Additionally the CPU/memory 1100 would be synched with the system accounts of the funds available for the player to download to a gaming terminal 100 for play (if such functionality is provided). The funds the player has residing in his/her electronic account would be represented by data stored at one or both of the system level and on the smart card 700. For example the smart card 700 CPU/memory 1100 may actually store data representing a value which is also stored at the system level. Alternatively the smart card 700 CPU/memory may store data representing a pointer to the data stored at the system level. In either case the data representing value is stored at the system level so that in the event the user's smart card 700 is lost or damaged, those funds remain accessible. If an error is found between the value data stored on the smart card 700 and at the system level, a suitable notification would be sent to the player to go to the casino cage to remedy the error. The error may be based upon a memory error, attempted “hacking” of the smart card 700 or other error. The system record would be the prevailing record.

The system also stores a record of the player's loyalty points. At 1208 the system retrieves any “aborted” gaming session by the player. It is a feature of the present invention that a player is not required to “log out” from a session of play at a gaming terminal 100 (or table game). For example, a player may exhaust their gaming credits at a gaming terminal 100 and simply leave. If the player institutes another session at the same or another gaming terminal 100 at 1208 the system recognizes the aborted session and at 1210 retrieves the aborted session data (win/loss history, time at the gaming terminal 100, accrued loyalty points) and at 1212 re-initiates the gaming session. If at 1208 no aborted session is determined at 1214 it is determined whether the player has initiated an active session at the gaming terminal 100. The system also determines at 1216 whether the player is also playing an adjacent gaming terminal 100. In either case at 1212 the gaming session is initiated. At 1218 the system, based upon the communication with the smart card 700 and the gaming terminals 100 player and their adjacency, determines whether the player is playing multiple gaming terminals 100. For example, some players enjoy playing two, adjacent, gaming terminals at the same time. At 1218 the system determines this situation and at 1220 transfers the active session of the adjacent gaming terminal 100 to the initiated gaming session at 1212 so the player gets credit for the play of the gaming terminals 100.

It is a feature of an embodiment of the present invention that the smart card 700 facilitates cashless and ticketless gaming. Accordingly, at enrollment according to this embodiment, the user has an account (sometimes referred to as an e-account, virtual wallet or the like) established at one or more system servers. This account retains data regarding (1) the current balance of available funds and (2) historical data of transactions regarding the account, e.g. deposits and withdrawals. The smart card 700 is capable for storing data corresponding to an amount of money available to the player for gaming or purchasing goods or services. This value may be loaded onto the smart card 700 in several different ways. One way is for the player to insert cash into a gaming terminal 100 to initially establish credits and later to cash out by uploading the cash value of the remaining credits to the smart card 700 and system. Another way is to load cash is through a provided kiosk where the player may load funds through cash, credit card, debit card transaction or the like. Funds may also be loaded into the account through an established casino credit line and transferring funds from that credit line to the player's account at a kiosk, gaming terminal 100 or through a transaction at the casino cage. Value may also be added by the casino as a promotion. The player may add funds to and draw funds from the account at the gaming terminal 100, a provided transaction kiosk, at the casino cage or at a point of sale location for the purchasing of goods or services. The current value of the player's account may be replicated into the CPU/memory 1100 of the smart card 700 and/or the CPU/memory 1100 includes data to point to the account for access thereto.

Continuing with FIG. 11, at 1222 the player may perform a transaction such as downloading or uploading funds from their electronic account to/from the gaming terminal 100. In an embodiment, the player may select at the PTM 511 or at the display 104 for the gaming terminal 100 to, for example, download funds to the gaming terminal 100 for gaming. Making a selection for this transaction by depressing a button at the PTM 511 may, according to one embodiment, call up a display 1300 as suggested in FIG. 10 which displays value increment and maximum transfer buttons 1302 a-f. In the example shown in FIG. 10, the player has $124.56 in their account as shown at transfer button 1302f. The player may elect to download all of the account value to the gaming terminal 700 by activating transfer button 1302f or a lesser amount of $10 (transfer button 1302a), $20 (transfer button 1302b), $50 (transfer button 1302c), $75 (transfer button 1302d) or $100 (transfer button 1302e). The maximum transfer button 1302 f may be configured to be the total value in the account, a maximum value configured by the user, the casino or regulators. The user may configure a default amount by depressing button 1304. To download funds the player would be required to use their PIN and/or a biometrical identifier such as fingerprint, facial, palm, retina, etc. identification devices at the gaming terminal 100 to prevent unauthorized access the funds. Likewise the player can upload all or a portion of the credit value at the gaming terminal 100 (or gaming table) to the account as well. The upload can be configured by permitting bulk uploading of the entire value or uploading in value increments. For example, if the player has $170 value at the gaming terminal 100 in credits they may choose to upload $100, a smaller or greater amount or the entire $170. At 1224 the system queries as to whether the player has terminated the gaming session. For example the player may actively terminate the session by uploading any remaining value from the gaming terminal 100 to the system and logging off. Logging off may be done by selecting a “log off” or “terminate session” at a display on the PTM 511 or gaming terminal display 104. When the player logs off, the session at 1226 synchs the system data to the data stored at the smart card CPU/memory 1000 and at 1228 terminates the session. According to an embodiment of the present invention the player need not actively take steps to log off or terminate a gaming session at the gaming terminal 100. At 1230 the system may determine that the player is no longer present thereby de facto terminating the session. If the tested parameters such as the player uploading all the value from the gaming terminal 100 to their account with/without a cessation in play for a predetermined period of time, exhaustion of credits from the gaming terminal 100 with/without a cessation in play for a predetermined period of time, the failure to detect the smart card 700 in the gaming terminal 100 NFC field, or passive detection such as biometrics (digital camera, heat sensor, for example), If the system at 1230 determines that the player is still present and the session is not concluded, the session remains in an open condition. If it is determined at 1230 that the player is no longer present at 1232 any lingering data from the session, e.g. value remaining at the gaming terminal 100 or un-accrued loyalty points are transferred to the system server and the session is terminated. Any value or points transferred according this embodiment would be synched with the player's smart card 700 the next time the player interfaces with the system.

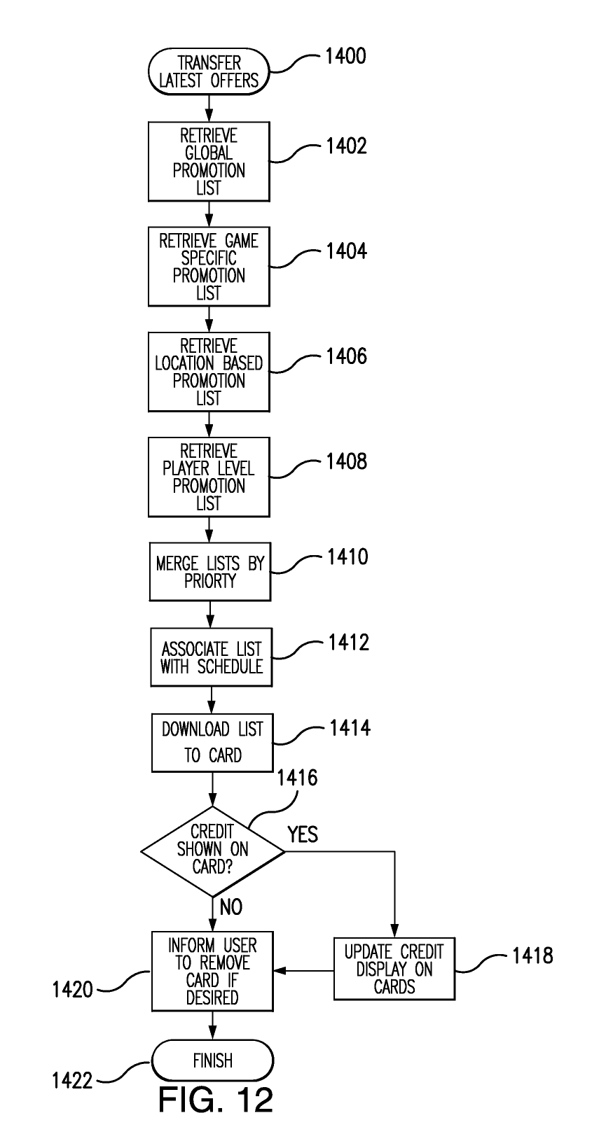

FIG. 12 illustrates a process diagram for player promotion delivery and acceptance. After the player has been recognized by the system as described herein and while their smart card 700 remains active and in communication with the NFC at the gaming terminal 100, at 1400 the promotion delivery process module at one or more system servers is accessed and starts the process. At 1402 the latest global promotion list is retrieved from a suitable data structure, such as, for example, promotions of the type listed in Table 1 above. At 1404, 1406 and 1408, respectively, game specific promotions, location specific promotions and player level specific promotions are retrieved from one or more data structures. These promotions may be of the type described above. At 1410 the promotions are merged by priority as configured by the administrator. For example the priority may be global offers (across multiple properties), property specific offers, tier specific offers, game-type specific offers and perhaps individual specific offers. These merged offers are then associated with the configured schedule for issuing such offers at 1412. Depending upon the priority and schedule and promotion entitlement, at 1414 the promotions are downloaded or merged to the user's smart card and the user's account by, for example, overwriting existing data or only writing to the memory the updates, changes or additions. If at 1416 gaming credits are shown on the smart card 700 at for example at the display 1000, at 1418 the credit display is updated to the current value as reflected at the server level. For example, as a promotion, the player may be awarded promotional credits for gaming which would be added to those formerly available to the player and the display 1000 would be refreshed to the current value. In the event the value is also saved at the smart card CPU/memory 1100 the memory is also refreshed to harmonize the value data with that reflected at the server level. If at 1416 no credits are displayed or after the credit values have been refreshed at 1418, at 1420 the player is informed by a message at a display or a sound that their card can be removed from the NFC field and the process is finished at 1422.

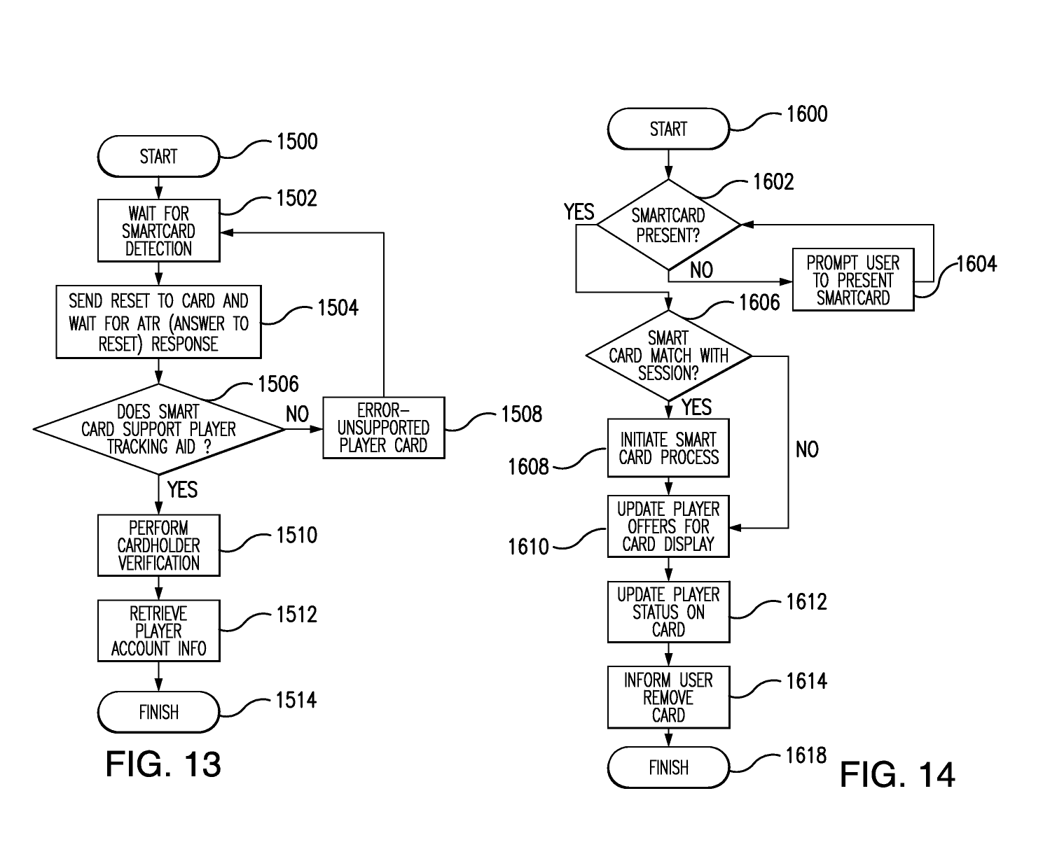

Turning to FIG. 13 the process for recognition of an authorized smart card 700 and retrieval of player information is illustrated. At 1500 the process is initialized as, for example, the system including the network of gaming devices 100 NFC readers 555 being activated. At 1502 the system is configured to broadcast a NFC signal for detection of a smart card 700. At 1504 an NCF card reader 555 sends a configured reset signal to a smart card 700 in its field and waits for a “transponding” answer from the smart card 700. If at 1506 the card reader 555 and system determine if an appropriate and configured response is received. If not at 1508 an error message is generated and may be displayed at a display at the terminal and/or smart card 700. In an embodiment the panel 1004 may turn a color such as red to indicate that there is a problem with the communication between the smart card 700 and the card reader 555. The error may be as a result of a defect, improper configuration of the smart card 700 or that the smart card 700 presented is not one recognized by the system, e.g. is a bank card or card from another provider. If at 1506 a proper response is received at 1510 the smart card 700 is verified as being active and the communication link is established. The establishment of the link may include the exchange of encrypted messages as well as the player inputting the required PIN number as described above. Once the communication link has been established at 1512 the player information in the player account as well as promotion and account updates are retrieved at the system server as described above and the data is downloaded and refreshed. This data may be stored at the system level or on both the smart card 700 and at the system level. Once the data has been updated at 1514 the process is completed and the player receives a message or tone that their smart card 700 can be removed from the field of the card reader 555.

FIG. 14 illustrates the synchronization process for the smart card 700 to sync up player data as well as any saved game states in environments where games are provided which offer the ability to save and transfer game state. At 1600 the process is initialized as, for example, the system including the network of gaming devices 100 NFC card readers 555 being activated. At 1602 the presence of an authorized smart card 700 is detected and if not at 1604 a message or signal is sent to the player to present their smart card 700 for detection by the NFC card reader 555. If an authorized smart card 700 is detected at 1602 at 1606 it is determined by the system if the detected card 700 is one which matches with an ongoing gaming session. By ongoing gaming session what is meant is that the player has been identified and play (serial wagering activity) at a gaming machine 100 or gaming table has commenced. This activity earns the player loyalty points toward benefits such as certain promotions as described above. If the smart card 700 matches with smart card whose session was already begun at 1608 the smart card process is initiated. The process includes accumulation of data based upon the activity of the player which is stored at the server as well as the selected exercise of promotions which may be available to the player and the application/saving of game state, if applicable for the particular gaming machine 100 being played by the player. If the smart card 700 does not match with an ongoing session such as when a prior player has walked away and a new player is presented, at 1610 the new player's smart card 700 and account are updated with available promotions and at 1612 the player's status is updated as well. These updates, according to an embodiment of the invention, are reflected at the smart card display 1000 and panel 1004. For example, one or more of the accepted/available promotions may be displayed at the display 1000 as suggested in FIG. 8. The updates and current status of the player's loyalty point account and electronic funds account may also be displayed. Note that the display of certain information such as available funds and player points may require the user to unlock the smart card 700 and enter a PIN. Still further the panel 1004 may be controlled to a color, pattern or graphic to indicate information to the player such as the player's tier level or the saved states of one or more games. Using various button the player may be able to segue though a menu displayed at the display 1000 with the panel 1004 changing to confer information at a glance to the player concerning the then displayed menu item. For example, the player may segue to “Player status” displayed at the display 1000 and the panel 1004 assumes a gold color to indicate to the player their status. The player may segue to a menu listing for a game having a saved state feature whereupon the panel 1004 assumes a yellow color with a graphic number “2” indicating the player has achieved and saved a level 2. These are but non limiting examples of the display 1000 and panel 1004 of the smart card 700. Once the smart card 700 has been updated at 1612 the player is informed at 1614 that the update process is complete and they may remove the smart card 700 from the NFC field, at 1618 the process is terminated.

In regards to the foregoing the player can also configure the smart card panel 1004 to one or a number of selected patterns or colors. For example, when the smart card 700 is brought into the NFC field and recognized, the PTM 511 may afford the player with an option to select, for example, a default color, pattern or graphic for the panel 1004. Where the panel encompasses a large area of a surface of the smart card 700, the player may choose a blue color for the panel 1004. This would therefore be the default color assumed by the panel. Depending on the information to be imparted to the player this color may change to reflect the player's tier, promotion availability, saved game state, account status or the like. In a non-limiting example, the player may select a pattern of squares which assumes a blue color to reflect the player's tier. When the player desire's to determine their saved state status with a game, using the buttons 1002 on the smart card 700 the player can call up the menu on the display 1000 for the game whereupon a portion of the panel assumes a yellow color and the number “2” indicting that the player has achieved a saved state of “2” for that game.

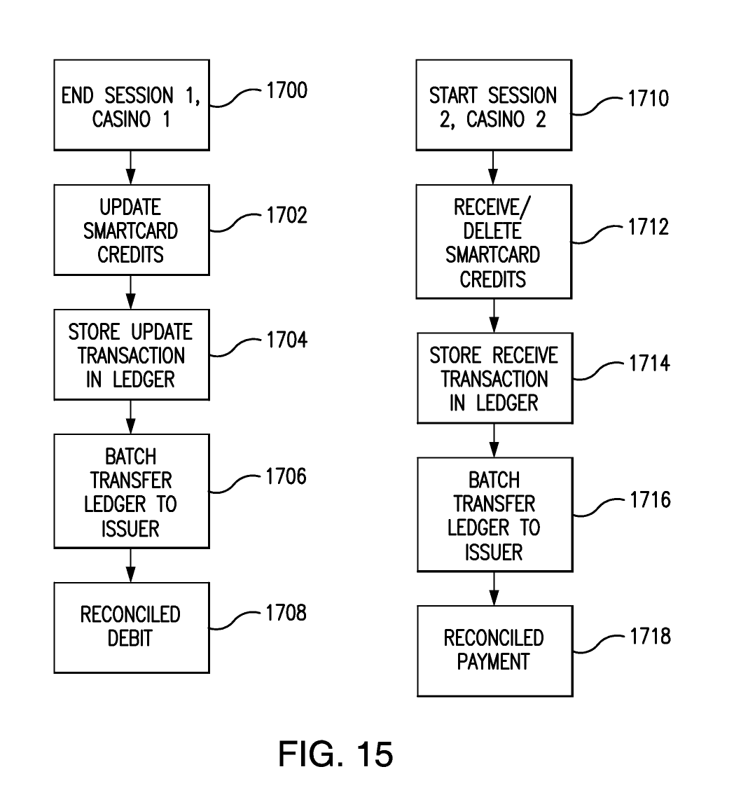

FIG. 15 illustrates the use of the smart card 700 in several casinos such as nearby, affiliated casino resorts. At 1700 the player ends his/her gaming session at gaming terminal 100 in Casino 1. The player's loyalty points as well as any remaining credits at the gaming terminal 100 are updated at 1702 and at 1704 stored in the smart card 700 and in a transaction ledger at the Casino 1 server. If for example, the player had wagered $20 and won $100, the total value of $120 may uploaded to the player's smart card 700 (with a duplicate confirmation copy to the player's system account) and the amount of $120 would be at 1704 stored in a Casino 1 transaction ledger as a debit and removed from the gaming terminal 100 credit meter. The $120 on the player's smart card 700 from Casino 1 is carried as a debit since those funds may be redeemed at Casino 1 or any other affiliated casino. At some point the transaction ledger (debits and credits) for all players would be batch transferred at 1706 to a clearing house server. For example, for a family of affiliated casino properties, one casino may be selected to house the clearing house server. Depending upon the geographical locations the batch transfer may occur overnight. However, where the casinos are geographically close, the batch transfer may have to be periodic such as every 15 minutes. At 1708 debits and credits are reconciled.

At 1710 the player takes their smart card 700 to affiliated Casino 2 and starts a gaming session. The player would, for example, download value stored in the smart card 700 to a gaming machine at Casino 2 for wagering. The downloading of value at 1712 would be reflected and stored at 1714 in a transaction ledger maintained at Casino 2 as a credit. The smart card 700 stored value would be reduced by the amount of the credit transferred to the gaming terminal 100. A server at the affiliated Casino 2 would save the transaction at the server level as well to provide a record. At 1716 Casino 2 sends their ledger data (debits and credits) in a batch process to the clearing house server for reconciliation. At 1718 all records at the Casino 1 and Casino 2 are reconciled so that the data regarding the player's account for both properties is consistent and up to date.

Various promotions and features may also be selected by displaying an active electronic poster, for example, at the display 104 for the gaming terminal 100 or the display 559 for the PTM 511. Using their smart card 700 the player may touch the poster whereupon the promotion is downloaded to the smart card 700 and copied to the player's system account. In a related embodiment the player may call up a listing of active promotions to be displayed at the gaming terminal 100 display 104 or PTM 511 display 559 and select promotions by touching their smart card 700 to a displayed icon or listing of the selected promotion or by entering a prompt at the smart card buttons 1002 or buttons associated with the displayed menu such as buttons 902 (FIG. 7) for the PTM 511 or buttons on a the gaming terminal 100 display 104 touch screen.

The smart card 700 CPU and memory 1100 may be configured to control the panel 1004 (FIG. 8) to display one or more conditions associated with promotions. For example, the player may unlock the smart card 700 and activate the display 1000. Using the buttons 1002 the user selects a promotion. The panel 1004 may assume a visual state associated with that promotion such as a color green to reflect that the promotion is still viable and may be exercised by the user, red to indicate that the promotion has expired or orange to indicate that the promotion is about to expire.

While the above description of various embodiments of the present invention have been directed to a smart card, it should be understood that other electronic devices configured for near field communication could be used alone or in conjunction with a smart card. For example, a user may have a cellular telephone having NFC, processing and display functionalities described above. The user would establish their system account and configure their cellular telephone for NFC with the terminals and to operate as described above. Similarly a tablet computer, laptop computer or PDA could likewise be configured. Where the displays of such devices permit there may be multiple panels such as the singular panel 1004 of smart card 700 (or smart card 700 may be configured to have multiple display panels 700) so that visual states of various conditions may be displayed simultaneously. For example, one panel may display the user's tier, and others the saved states of various games and the state of promotions. Regarding promotions, the color of the panel(s) 1004 may change as an active promotion approaches expiration. Preferably for all embodiments at least the panel(s) 1004 remains in a display condition even though the smart card 700 is locked and not in communication with a system. That is, a user may view the smart card 700 (or other device as described above) at any time and the panel(s) 1004 would reflect the desired or selected visual state. The panel(s) 1004 persists under the power of the battery 1102, if required.

As stated above the methods and system of the present invention are compatible with other loyalty programs as well such as airline frequent flier programs and retailer loyalty programs. Kiosks or terminals would be provided with NFC capability to download and upload information between the smart card (and/or other device) as described above. The user's loyalty points or credits would be displayed. For example where the smart card 700 is part of an airline frequent flier program, the panel 1004 may assume a color based upon the customer's account status entitling the user to priority boarding, free bag check-in, seat upgrades and the like.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A method for operating a loyalty system for an environment including a plurality of user terminals, a system host computer, a data structure, a communication network between said host computer and said terminals and a portable device in possession of each user, each portable device including a controller to control a display, said method comprising:
providing for storage at said data structure data corresponding to one or more of user account data and promotional data;
enabling contactless, near field communication between a portable device in possession of a user and said network at one of said user terminals, one or more of said controller and host controlling a display on said portable device to display messages to the user and one or more of said display and a visually configurable panel to assume a visual state corresponding to one or more of said account data and said promotional data.

2. The method of claim 1 wherein said data structure stores data corresponding to a ranking assigned to each user from a plurality of possible rankings, said method comprising controlling one of said display and panel to assume visual state corresponding to said ranking.

3. The method of claim 2 comprising controlling one of said display and panel to assume a color based upon said ranking.

4. The method of claim 1 comprising controlling an e-ink panel on said device to a visual state corresponding to one or more of said account data and said promotional data.

5. The method of claim 4 wherein said device is a smart card, the method comprising controlling an e-ink panel defining at least a portion of a surface of said smart card to a visual state corresponding to one or more of said account data and said promotional data.

6. The method of claim 5 comprising controlling said e-ink panel to a color.

7. The method of claim 5 comprising the user through an input device controlling at least a portion of said e-ink panel to a selected visual state.

8. The method of claim 1 comprising providing for the storage of data corresponding to a value at one or more of a data structure associated with said device and said system data structure and enabling the transfer of at least a portion of said value between said device data structure to one or more of said terminal or network.

9. The method of claim 1 comprising providing for the storage of data corresponding to a value at one or more of a data structure associated with said device and said system data structure and enabling the display at the device to display at said display information related to said value.

10. The method of claim 1 comprising displaying an active poster at a terminal representing an event including one or more of a promotion, service, game or information and, in response to a user registering their portable device with the poster, controlling one of said display and panel to display a visual indication of communication of event data between said terminal and said device.

11. The method of claim 10 comprising displaying said active poster at a video display at said terminal.

12. The method of claim 1 comprising providing a user input device at one of said terminals or portable device.

13. The method of claim 12 comprising providing for said user to select at said input device a configuration of at least a portion of said panel.

14. The method of claim 1 comprising controlling at least one of said display and panel to display a visual image based upon a promotion available to said user.

15. The method of claim 1 comprising enabling the storage of data corresponding to loyalty points available to the user at of at one or more of a data structure associated with said device and said system data structure and providing for the display at said display of the user's loyalty points.

16. The method of claim 1 comprising at least one of said device and data structure storing data corresponding to a key and enabling a user input device at one of said terminal or portable device to input said key to enable communication between said device and said terminal or network.

17. A method for operating a casino loyalty system for an environment including a plurality of gaming terminals, a system host computer, a host data structure, a communication network between said host computer, said terminals and said host and a portable device in possession of each user, each portable device including a controller to control (i) a device display, said method comprising:
providing for the storage at said data structure data corresponding to one or more of player account data and promotional data;
enabling contactless, near field communication between a portable device in possession of a player and said network at one of said user terminals, one or more of said controller and host controlling a display on said portable device to display messages to the user and one or more of said display and a visually configurable panel to assume a visual state corresponding to one or more of said account data and said promotional data.

18. The method of claim 17 comprising enabling said controller to control a panel at said device to a visual state.

19. The method of claim 17 wherein said host data structure stores for each user a ranking from a group of rankings, said method comprising enabling said controller to control at least a portion of said panel to a visual state corresponding to ranking of the user.

20. The method of claim 17 comprising providing for a device data structure for each portable device to store data.

21. The method of claim 20 comprising providing storage at least at one of said host data structure and said device of data corresponding to a value amount.

22. The method of claim 21 comprising enabling the transfer of data corresponding to said value amount between said device data structure and one or more of said terminal, network and host data structure.

23. The method of claim 17 comprising providing a user interface at one or more of said terminal and said device.

24. The method of claim 23 comprising providing at said device said user interface as a keypad including at least one button.

25. The method of claim 17 wherein a plurality of said gaming terminals include a game having various states achieved during play, said method comprising enabling data corresponding to said state to be saved at one or more of said host data structure and a data structure associated with said portable device and to be recalled at a later time to re-instate said game state at one of the same or other gaming terminal.

26. The method of claim 25 comprising controlling one of said display said visually configurable panel to display one of a message or visual state corresponding to said saved game state.

27. A system for operating a loyalty system for an environment including a plurality of terminals, a system host computer, a host data structure, a communication network between said host computer, said terminals, said host and a portable device in possession of each user, each portable device including a controller to control a device display, said system comprising:
said host data structure data configured to store data corresponding to one or more of player account data and promotional data;
a visually configurable panel at said portable device; and
communication apparatus for contactless, near field communication between said portable device in possession of a user and said network at one of said user terminals, one or more of said controller and host configured to control (i) said display on said portable device to display messages to the user and (ii) one or more of said display and said visually configurable panel to assume a visual state corresponding to one or more of said account data and said promotional data.

28. The system of claim 27 comprising said host data structure configured to store data corresponding to a ranking assigned to each user from a plurality of possible rankings, and one or more of said controller and host configured to control one of said display and panel to a color based upon said ranking.

29. The system of claim 27 comprising said panel is an e-ink panel.

30. The system of claim 28 comprising said device is a smart card and said panel is an e-ink panel defining at least a portion of a surface of said smart card.

31. The system of claim 30 comprising controlling said e-ink panel to a color.

32. The system of claim 27 comprising a user input device configured to select the visual state of at least a portion of said e-ink panel.

33. The system of claim 27 comprising a device data structure associated with said device, one of said system data structure and device data structure configured to store of data corresponding to a value and said data structures, controller, host and network configured to transfer of at least a portion of said value between said one of said system data structure and device data structure to one or more of said terminal or network.

34. The system of claim 27 comprising configuring a terminal to display an active poster representing a feature including one or more of a promotion, service, game or information and, configuring one of said display and panel to display a visual indication of communication of data related to said feature between said terminal and said device in response to a user registering their portable device with the poster.

35. The system of claim 34 comprising configuring said terminals to display said active poster at a video display at said terminal.
